(19) United States
(12) Patent Application Publication
(10) Pub. No.: US 2021/0342414 A1
(43) Pub. Date: Nov. 4, 2021

(54) ASYMMETRIC INFORMATION FLOW READING METHOD AND APPARATUS, TERMINAL AND STORAGE MEDIUM

(71) Applicant: Chutong Technology (Shanghai) Co., Ltd., Shanghai (CN)

(72) Inventor: Dengke DU, Shanghai (CN)

(73) Assignee: Chutong Technology (Shanghai) Co., Ltd., Shanghai (CN)

(21) Appl. No.: 17/372,553

(22) Filed: Jul. 12, 2021

Related U.S. Application Data
(63) Continuation of application No. PCT/CN2020/085448, filed on Apr. 18, 2020.

(30) Foreign Application Priority Data
Mar. 16, 2020 (CN) 202010182335.5

(51) Int. Cl. G06F 16/957; G06F 40/106

(52) U.S. Cl. CPC G06F 16/9577; G06F 40/106

(57) ABSTRACT

The method asymmetric information flow reading mainly includes: a width and a height of the original information flow are preprocessed, the preprocessed information flow is stacked in a highly adaptive equal-width manner, information flow to be displayed after being preprocessed is allocated into a first information flow site and a second information flow site that are configured in advance respectively for concurrent display, detailed information of a required information element is displayed in the first information flow site according to a reading request of a user in any information flow site, and the first information flow is loaded into the second information flow site. With the adoption of the asymmetric information flow reading method and the asymmetric information flow reading apparatus, an inside page may be opened in a home page in an embedded manner by designing a dual information flow mode without changing an original information flow style.

### CROSS REFERENCE TO THE RELATED APPLICATIONS

This application is the national phase entry of International Application No. PCT/CN2020/085448, filed on Apr. 18, 2020, which is based upon and claims priority to Chinese Patent Application No. 202010182335.5, filed on Mar. 16, 2020, the entire contents of which are incorporated herein by reference.

### TECHNICAL FIELD

The disclosure relates to the technical field of information display, and in particular to an asymmetric information flow reading method and apparatus, a terminal and a storage medium.

### BACKGROUND

In an information era, information flow has been widely applied to social contact, news, video, blog and other platforms. Due to lack of uniform standard, the way representation of the information flow is diversified. For example, the information flow, similar to Kuaishou, Xiaohongshu and Dianping.com is stacked in an equal-width and non-equal-height manner, a user may enter the information into an inside page after clicking a graphic and text module and need to return to a home page for re-selection, and content reading of the user in each step may be limited. The information flow, similar to TikTok, adopts a flat design. The user may enter the information into the inside page directly, a suitable short video will be recommended through an algorithm, however it lacks an active selection interface. In terms of the information flow, similar to bilibili and Tencent Video, the user may be allowed to view the inside page while selecting the content of the home page, however the content of the information flow must be equal in width and height.

To achieve strong compatibility, namely, to realize an information flow operating interface that is user-friendly and aesthetically pleasing, two main issues need to be solved, namely, adaptation to sizes of various information flows and embedded opening of the inside page. However, there is a conflict between the two, because an information flow sorting algorithm is fixed, an original information flow style may not be changed when opening the inside page, while the inside page may not be opened without changing the original information flow style.

### SUMMARY

Embodiments of the disclosure provide an asymmetric information flow reading method and apparatus, a terminal, and a storage medium. An inside page may be opened in a home page in an embedded manner by designing a dual information flow mode without changing an original information flow style, and accordingly a readable and beautiful information flow operating interface is realized.

A first aspect of the embodiments of the disclosure provides an asymmetric information flow reading method. The asymmetric information flow reading method may include the following steps.

A width and a height of the original information flow are preprocessed, and the preprocessed information flow is stacked in a highly adaptive equal-width manner.

The information flow to be displayed after being preprocessed is allocated into a first information flow site and a second information flow site that are configured in advance respectively for concurrent display, the information flow displayed in the first information flow site being first information flow, and the information flow displayed in the second information flow site being second information flow

Detailed information of a required information element is displayed in the first information flow site according to a reading request of a user in any information flow site, and the first information flow is loaded into the second information flow site.

Further, after the steps that the detailed information of the required information element is displayed in the first information flow site according to the reading request of the user in the any information flow site, and the first information flow is loaded into the second information flow site, the method may further include the following step.

Detailed information of an information element that is being displayed in the first information flow site is substituted with detailed information of a newly required information element when a new reading request input in the second information flow site is detected.

Further, the method may include the following steps.

The two information flow sites are restored to concurrently display a display status of the information flow when a closing request in allusion to the information element displayed in the first information flow site is detected.

Further, the step that the two information flow sites are restored to concurrently display the display status of the information flow may include the following step.

The first information flow is reloaded into the first information flow site, and the first information flow in the second information flow site is deleted.

Or, the information flow to he displayed after being preprocessed is reallocated into the first information flow site and the second information flow site respectively for the concurrent display.

Further, when the detailed information of the required information element is displayed in the first information flow site, the method may further include the following step.

The first information flow and the second information flow that are being displayed in the second information flow site are refreshed according to an input information flow refreshing request.

A second aspect of the embodiments of the disclosure provides an asymmetric information flow reading apparatus. The asymmetric information flow reading apparatus may include:

an information preprocessing module, configured to preprocess a width and a height of the original information flow, and stacking the preprocessed information flow in a highly adaptive equal-width manner;

an in-site display module, configured to allocate the information flow to be displayed after being preprocessed into a first information flow site and a second information flow site that are configured in advance respectively for concurrent display, the information flow displayed in the first information flow site being first information flow, and the information flow displayed in the second information flow site being second information flow; and

a reading response module, configured to display detailed information of a required information element in the first information flow site according to a reading request of a user in any information flow site, and load the first information flow into the second information flow site.

Further, the apparatus may further include:

a display transformation module, configured to substitute detailed information of an information element that is being displayed in the first information flow site with detailed information of a newly required information element when a new reading request input in the second information flow site is detected.

Further, the apparatus may further include:

a display restoring module, configured to restore the two information flow sites to concurrently display a display status of the information flow when a closing request in allusion to the information element displayed in the first information flow site is detected.

Further, the display restoring module may further include:

a first restoring unit, configured to reload the first information flow in the first information flow site, and delete the first information flow in the second information flow site; or

a second restoring unit, configured to reallocate the information flow to be displayed after being preprocessed to the first information flow site and the second information flow site respectively for concurrent display.

Further, the apparatus may further include:

an information refreshing module, configured to refresh the first information flow and the second information flow that are being displayed in the second information flow site according to an input information flow refreshing request. A third aspect of the embodiments of the disclosure provides a computer storage medium. The computer storage medium stores multiple instructions, and the instructions are suitable for being loaded by a processor and executing the following steps.

A width and a height of the original information flow are preprocessed, and the preprocessed information flow is stacked in a highly adaptive equal-width manner.

The information flow to be displayed after being preprocessed is allocated into a first information flow site and a second information flow site that are configured in advance respectively for concurrent display, the information flow displayed in the first information flow site being first information flow, and the information flow displayed in the second information flow site being second information flow.

Detailed information of a required information element is displayed in the first information flow site according to a reading request of a user in any information flow site, and the first information flow is loaded into the second information flow site.

A fourth aspect of the embodiments of the disclosure provides a terminal. The terminal may include: a processor and a memory, herein, the memory stores a computer program, and the computer program is suitable for being loaded by the processor and executing the following steps.

A width and a height of the original information flow are preprocessed, and the preprocessed information flow is stacked in a highly adaptive equal-width manner.

The information flow to be displayed after being preprocessed is allocated into a first information flow site and a second information flow site that are configured in advance respectively for concurrent display, the information flow displayed in the first information flow site being first information flow, and the information flow displayed in the second information flow site being second information flow

Detailed information of a required information element is displayed in the first information flow site according to a reading request of a user in any information flow site, and the first information flow is loaded into the second information flow site.

The beneficial effects of the disclosure are as follows: when subjected to width locking and height adaptation, the information flow to be displayed is displayed through the two information flow sites in a current page, in this way the user may view the detailed information in allusion to the reading request in any information flow site without skipping, and display of the information flow in another site will not be influenced. Accordingly, repeated return will be avoided, and a situation in which an original target may not be found after returning to the home page due to misoperation is prevented. With the adoption of the abovementioned asymmetric information flow reading mode, the inside page may be opened in an embedded manner of the home page without changing the original information flow style, and accordingly it is widely comparative and ingenious.

### BRIEF DESCRIPTION OF THE DRAWINGS

In order to describe the embodiments of the disclosure or the technical solutions in the conventional art more clearly, the drawings required to be used in the description of the embodiments or the conventional art will be simply introduced below. It is apparent that the drawings described below are only some embodiments of the disclosure. Other drawings may further be obtained by those of ordinary skill in the art according to these drawings without creative work.

FIG. 1 is a flow diagram of an asymmetric information flow reading method provided by an embodiment of the disclosure.

FIGS. 2-5 are display effect schematic diagrams of information flow provided by embodiments of the disclosure.

FIG. 6 is a structure diagram of an asymmetric information flow reading apparatus provided by an embodiment of the disclosure.

FIG. 7 is a structure diagram of a display restoring module provided by an embodiment of the disclosure.

FIG. 8 is a structure diagram of a terminal provided by an embodiment of the disclosure.

### DETAILED DESCRIPTION OF THE EMBODIMENTS

The technical solutions in the embodiments of the disclosure will be clearly and completely described below in combination with drawings in the embodiments of the disclosure. It is apparent that the described embodiments are not all embodiments but part of embodiments of the disclosure. All other embodiments obtained by those of ordinary skill in the art on the basis of the embodiments in the disclosure without creative work shall fall within the scope of protection of the disclosure.

Terms “include”, “have” and any variations thereof in the description, the claims and the abovementioned drawings of the disclosure are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be optionally included instead.

In addition, terms “mount”, “configure”, “provide”, “connected”, “linked” and “sleeved” should be broadly understood. For example, it may be fixed connection, detachable connection, or integrally constructed. As an alternative, it may be mechanical connection, or electrical connection. As an alternative, it may be direct connection, or indirect connection through a medium, or internal connection between two apparatuses, elements or components. Those of ordinary skill in the art may understand the specific meanings of the abovementioned terms in the disclosure according to the specific situation.

It is to be noted that the embodiments in the application and features in the embodiments may be combined with each other without conflict. The application will be described below in detail with reference to the drawings and in combination with the embodiments.

A terminal involved in the embodiment of the disclosure may be a large computer, a Personal Computer (PC), a tablet computer, a handheld computer, a Mobile Internet Device (MID) and other terminal devices with capacity of processing data.

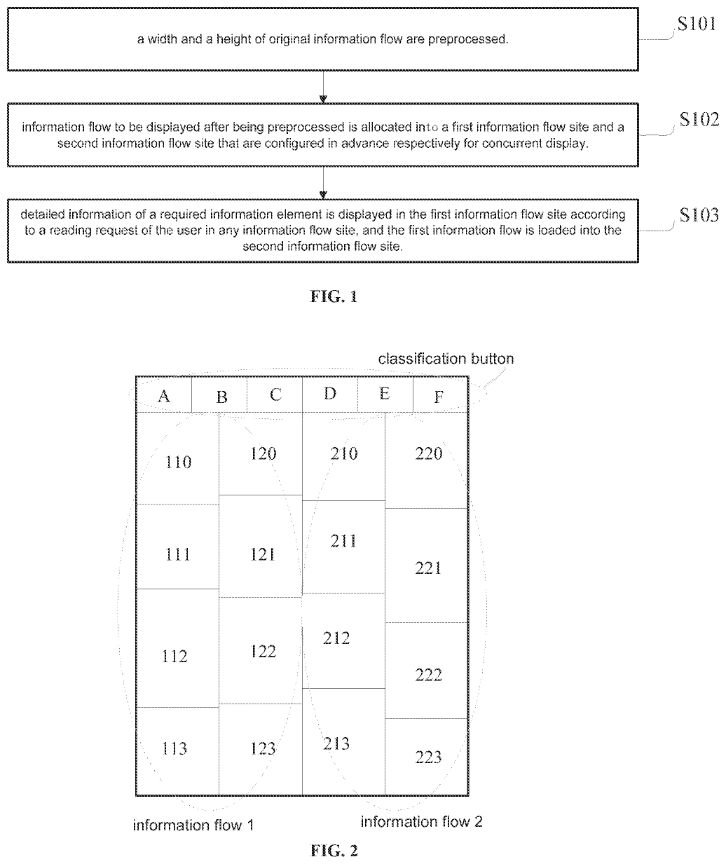

As shown in FIG. 1, in the embodiment of the application, an asymmetric information flow reading method may include at least the following steps.

S101, a width and a height of the original information flow are preprocessed.

It is to be understood that the original information flow may include various types of information flow, such as a time frequency, a picture or a character transferred from a third party platform or imported through an interface, and information flow from our party.

In practical implementation, the width of the original information flow may be locked according to a preset fixed width or a width proportion, while the height of the information flow may be subjected to adaptation according to a total height of a current display page and a specific display height of each information element, herein, the preset fixed width or the width proportion depends on a width of the current display page. For example, there are four lines of information flow in the current display page, the widths of the four lines of information flow are the same and are one quarter of the width of the current display page, while heights of all information elements of the each line of information flow are not necessarily the same. There are many contents in some elements and correspondingly the display height is long, while there are few content and correspondingly the display height is short, in this way the contents of the information flow are different from each other finally, and front end display aesthetic feeling and platform differentiation are shown through an irregular aligning mode. It is to be noted that the preprocessed information flow is stacked in a highly adaptive equal-width manner and allocated into a corresponding information flow site.

S102, information flow to be displayed after being preprocessed is allocated into a first information flow site and a second information flow site that are configured in advance respectively for concurrent display.

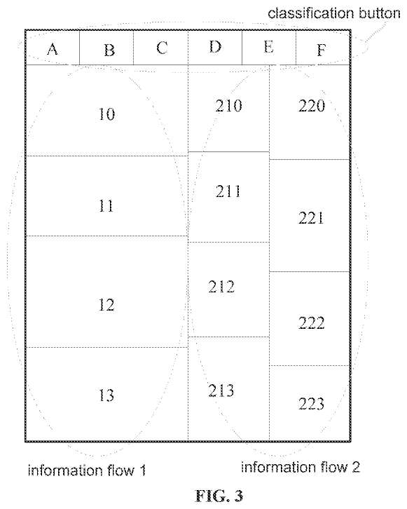

It is to be noted that there are at least two information flow sites in the current display page, and each information flow site displays at least one line of information flow therein. As shown in FIG. 2, there are two information flow sites in the current display page, namely, the first information flow site and the second information flow site. The information flow 1 (including information elements 110, 111, 112, 113 . . . ; 120, 121, 122, 123 . . . ) and the information flow 2 (including information elements 210, 211, 212, 213 . . . ; 220, 221, 222, 223 . . . ) that are respectively displayed in the first information flow site and the second information flow site are two lines of information flow, and four lines of information flow are finally shown in the current display page.

In an optional embodiment, as an alternative, numbers of the lines of information flow in different information flow sites may be different. As shown in FIG. 3, one line of information flow (including information elements 10, 11, 12, 13 . . . ) matching with historical data browsed by a user may be displayed in the first information flow site only, and two lines (including information elements 210, 211, 212, 213 . . . ; 220, 221, 222, 223 . . . ) may be displayed in the second information flow site. Under this circumstance, the terminal needs to lock the width of the information flow on the basis of calculation according to the information flow where the terminal is positioned, for example, a width of the information flow in the first information flow site is a half of the current display page, and a width of the information flow in the second information flow site is one quarter of the current display page.

S103, detailed information of a required information element is displayed in the first information flow site according to a reading request of the user in any information flow site, and the first information flow is loaded into the second information flow site,

It is to be noted that display of the information flow in each information flow site or reading of a single information element will not influence a display status of the information flow displayed in another information flow site. In addition, as an alternative, the information flow site configured to display the detailed information may be the second information flow site, and the specific site for displaying the detailed information may be determined according to a reading habit of the user. In the embodiment of the application, an example of displaying the detailed information in the first information flow site is mainly described.

In practical implementation, when the user clicks the information element in the any information flow site for reading, the terminal may acquire a corresponding request, extract corresponding detailed information according to the request, and further display the detailed information in the first information flow site and load the first information flow into the second information flow site. It is to be noted that the second information flow in the second information flow site previously is not lost when the first information flow is loaded into the second information flow site, and is still displayed in the second information flow site.

Its understandable that the first information flow site is configured to display the detailed information required by the user, while the first information flow originally displayed in the first information flow site is transferred into the second information flow site. In this way, the user may view selected detailed information and view all other information flow displayed in the first information flow site previously in the second information flow site. Preferably, when the detailed information is displayed in the first information flow site, the user may input an information flow refreshing request by clicking a classification button on a top of the page or sliding in the second information flow site and other modes, as to refresh the first information flow and the second information flow that are being displayed in the second information flow site. For example, when the user clicks an information element 210 in the display page shown in FIG. 2, as shown in FIG. 4, detailed information of the information element 210 is displayed in the first information flow site only, while the second information flow site looks the same from an inner surface, however, in fact, all information flow including the information flow 1 and the information flow 2 may view other information elements through the classification buttons (A, B, C, D, E, F) on the top or through sliding in the second information flow site.

Further, when the user browses other information flow in the second information flow site, a new reading request (for example, clicking the information element) may be sent in allusion to another information element in the information flow, and the terminal may substitute detailed information that is being displayed in the first information flow site with detailed information of a newly required information element. For example, when the user clicks an information element 221 in the display page shown in FIG. 4, as shown in FIG. 5, detailed information of the information element 221 is displayed in the first information flow site, while the second information flow site looks the same from an inner surface, however, in fact, all information flow including the information flow 1 and the information flow 2 may view other information elements through the classification buttons (A, B, C, D, E, F) on the top or through sliding in the second information flow site.

In an optional embodiment, the terminal may restore the two information flow sites to concurrently display the display status of the information flow when a closing request in allusion to the information element displayed in the first information flow site is detected. For example, when the user closes the detailed information that is being read in FIG. 4 or FIG. 5, the terminal may restore to the display status shown in FIG. 2. Specifically, an original display status may be restored through two modes. For example, the first information flow is reloaded into the first information flow site, and the first information flow in the second information flow site is detected. Or, the information flow to be displayed after being preprocessed is reallocated into the first information flow site and the second information flow site respectively for concurrent display.

In the embodiment of the disclosure, when subjected to width locking and height adaptation, the information flow to be displayed is displayed through the two information flow sites in a current page, in this way the user may view the detailed information in allusion to the reading request in any information flow site without skipping, and display of the information flow in another site will not be influenced. Accordingly, repeated return will be avoided, and a situation in which an original target may not be found after returning to a home page as a result of misoperation is prevented. With the adoption of the above mentioned asymmetric information flow reading mode, an inside page may be opened in an embedded manner of the home page without changing an original information flow style, and accordingly it is widely comparative and ingenious,

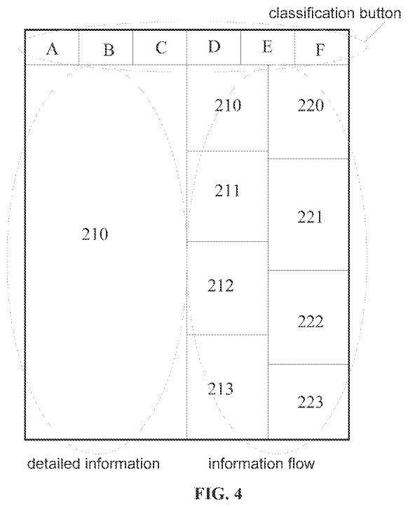

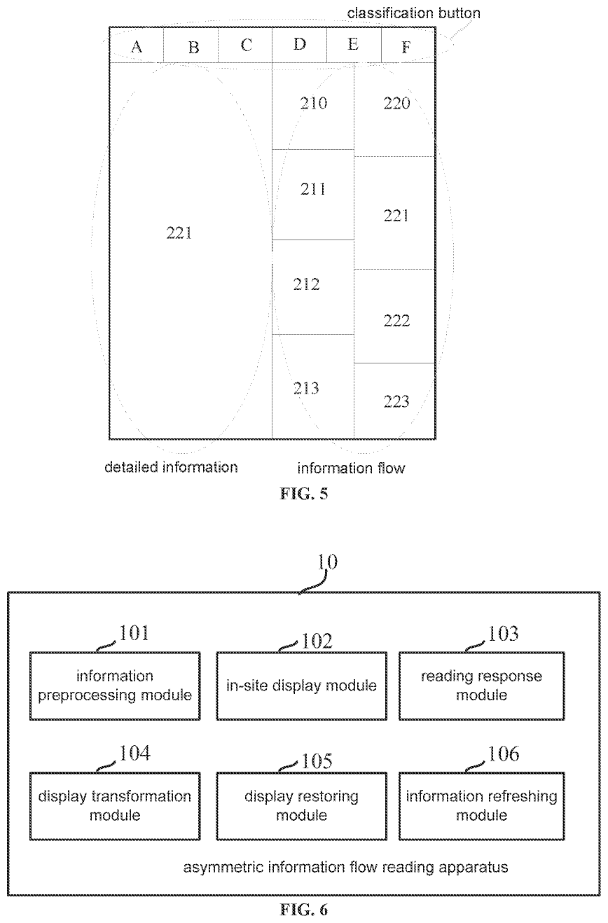

A sexual surge audio identifying apparatus provided by the embodiments of the disclosure will be introduced below in detail in combination with FIG. 6 and FIG. 7. It is to be noted that an asymmetric information flow reading apparatus shown in FIG. 6 and FIG. 7 are configured to execute the method of the embodiments shown in FIG. 1-FIG. 5 of the disclosure. In order to facilitate description, part related to the embodiments of the disclosure is shown only, and please use the embodiments shown in FIG. 1 and FIG. 5 for reference in terms of specific technical details not shown.

Please refer to FIG. 6, the embodiments of the disclosure provide a structure diagram of an asymmetric information flow reading apparatus. As shown in FIG. 6, the asymmetric information flow reading apparatus 10 of the embodiments of the disclosure may include: an information preprocessing module 101, an in-site display module 102, a reading response module 103, a display transformation module 104, a display restoring module 105 and an information refreshing module 106. Herein, the display restoring module 105 is shown in FIG. 7 and may include a first restoring unit 1051 and a second restoring unit 1052.

The information preprocessing module 101 is configured to preprocess a width and a height of the original information flow, and stack the preprocessed information flow in a highly adaptive equal-width manner.

The in-site display module 102 is configured to allocate information flow to be displayed after being preprocessed into a first information flow site and a second information flow site that are configured in advance respectively for concurrent display, the information flow displayed in the first information flow site being first information flow, and the information flow displayed in the second information flow site being second information flow.

The reading response module 103 is configured to display detailed information of a required information element in the first information flow site according to a reading request of a user in any information flow site, and load the first information flow into the second information flow site.

The display transformation module 104 is configured to substitute detailed information of an information element that is being displayed in the first information flow site with detailed information of a newly required information element when a new reading request input into the second information flow site is detected.

In an optional embodiment, the apparatus 10 may further include the information refreshing module 106, configured to refresh the first information flow and the second information flow that are being displayed in the second information flow site according to an input information flow refreshing request.

The display restoring module 105 is configured to restore the two information flow sites to concurrently display a display status of the information flow when a closing request in allusion to the information element displayed in the first information flow site is detected.

In an optional embodiment, the display restoring module 105 may further include:

the first restoring unit 1051, configured to reload the first information flow into the first information flow site, and delete the first information flow from the second information flow site; or

the second restoring unit 1052, configured to reallocate the information flow to be displayed after being preprocessed into the first information flow site and the second information flow site respectively for concurrent display.

It is to be noted that the description in the embodiments of the abovementioned method may be used for reference in terms of detailed executing processes of each module and each unit in the abovementioned system, and these detailed executing processes will not be elaborated herein.

In the embodiment of the disclosure, when subjected to width locking and height adaptation, the information flow to be displayed is displayed through the two information flow sites in a current page, in this way the user may view the detailed information in allusion to the reading request in any information flow site without skipping, and display of the information flow in another site will not he influenced. Accordingly, repeated return will be avoided, and a situation in which an original target may not be found after returning to a home page as a result of misoperation is prevented. With the adoption of the abovementioned asymmetric information flow reading mode, an inside page may be opened in an embedded manner of the home page without changing an original information flow style, and accordingly it is widely comparative and ingenious.

The embodiments of the disclosure further provide a computer storage medium. The computer storage medium may store multiple instructions, and the instructions are suitable for being loaded by a processor and executing steps of a method in the embodiments shown in the abovementioned FIG. 1-FIG. 5. Moreover, the specific description in the embodiments shown in FIG. 1-FIG. 5 may be used for reference in terms of detailed executing processes, and these detailed executing processes will not be elaborated herein.

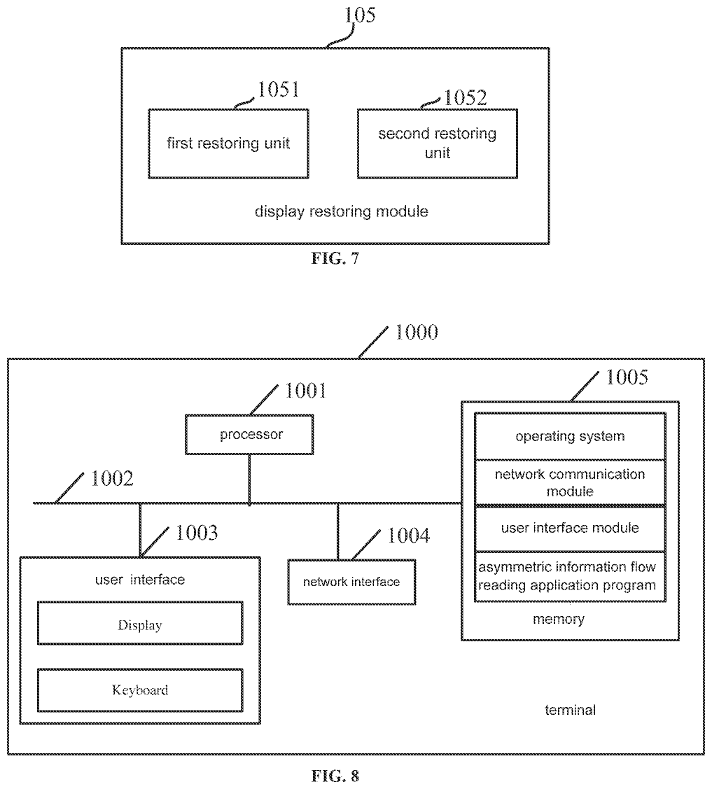

Please refer to FIG. 8, the embodiments of the disclosure provide a structure diagram of a terminal. As shown in FIG. 8, the terminal 1000 may include: at least one processor 1001, for example, a CPU, at least one network interface 1004, a user interface 1003, a memory 1005 and at least one communication bus 1002. Herein, the communication bus 1002 is configured to realize connection and communication between these components. Herein, the user interface 1003 may include a display and a keyboard, and the user interface 1003 is optional and may further include a standard wired interface and a standard wireless interface. The network interface 1004 may optionally include a standard wired interface and a standard wireless interface (such as a Wireless Fidelity (WI-FI) interface). The memory 1005 may be a high-speed Random Access Memory (RAM) and, as an alternative, a non-volatile memory, for example, at least one disk memory. As an alternative, the memory 1005 may optionally be at least one storage apparatus far away from the abovementioned processor 1001. As shown in FIG. 8, the memory 1005 as a computer storage medium may include an operating system, a network communication module, a user interface module and an asymmetric information flow reading application program.

In the terminal 1000 shown in FIG. 8, the user interface 1003 is mainly configured to provide a user with an input interface, as to acquire data input by the user, the network interface 1004 is configured to implement data communication with a client, while the processor 1001 may be configured to call the asymmetric information flow reading application program stored in the memory 1005 and specifically execute the following operations.

A width and a height of the original information flow are preprocessed, and the preprocessed information flow is stacked in a highly adaptive equal-width manner.

The information flow to be displayed after being preprocessed is allocated into a first information flow site and a second information flow site that are configured in advance respectively for concurrent display, the information flow displayed in the first information flow site being first information flow, and the information flow displayed in the second information flow site being second information flow.

Detailed information of a required information element is displayed in the first information flow site according to a reading request of the user in the any information flow site, and the first information flow is loaded into the second information flow site.

In some embodiments, after displaying the detailed information of the required information element in the first information flow site according to the reading request of the user in the any information flow site, and loading the first information flow into the second information flow site, the processor 1001 is further configured to execute the following operation.

The detailed information of an information element that is being displayed in the first information flow site is substituted with the detailed information of a newly required information element when a new reading request input into the second information flow site is detected.

In some embodiments, the processor 1001 is further configured to execute the following operation.

Two information flow sites are restored and a display status of the information flow is displayed concurrently when a closing request in allusion to the information element displayed in the first information flow site is detected.

In some embodiments, when restoring the two information flow sites and displaying the display status of the information flow concurrently, the processor 1001 specifically executes the following operations.

The first information flow is reloaded into the first information flow site, and the first information flow is deleted from the second information flow site.

Or, the information flow to be displayed after being preprocessed is relocated into the first information flow site and the second information flow site respectively for concurrent display.

In some embodiments, when displaying the detailed information of the required information element shown in the first information flow site, the processor 1001 specifically executes the following operation.

The first information flow and the second information flow that are being displayed in the second information flow site are refreshed according to an input information refreshing request.

In the embodiment of the disclosure, when subjected to width locking and height adaptation, the information flow to be displayed is displayed through the two information flow sites in a current page, in this way the user may view the detailed information in allusion to the reading request in any information flow site without skipping, and display of the information flow in another site will not be influenced. Accordingly, repeated return will be avoided, and a situation in which an original target may not be found after returning to a home page as a result of misoperation is prevented. With the adoption of the abovementioned asymmetric information flow reading mode, an inside page may be opened in an embedded manner of the home page without changing an original information flow style, and accordingly it is widely comparative and ingenious.

Those of ordinary skill in the art should know that: all or part of the process in the abovementioned embodiment method may be implemented by instructing related hardware through a computer program, the program may be stored in a computer-readable storage medium, and when being executed, the program may include a process of the abovementioned method embodiments. Herein, the storage medium may be a magnetic disk, an optical disk, a Read-Only Memory (ROM), or a Random Access Memory (RAM).

The above is only the preferred embodiments of the disclosure and not intended to limit the claims of the disclosure. Therefore, equivalent replacements made according to the claims of the disclosure shall fall within the scope covered by the disclosure.

What is claimed is:

1. An asymmetric information flow reading method, comprising:
preprocessing a width and a height of an original information flow, and stacking the preprocessed information flow in a highly adaptive equal-width manner;
allocating the information flow to be displayed after being preprocessed into a first information flow site and a second information flow site that are configured in advance respectively for concurrent display, wherein the information flow displayed in the first information flow site is first information flow, and the information flow displayed in the second information flow site is second information flow;
displaying detailed information of a required information element in the first information flow site according to a reading request of a user in any information flow site, and loading the first information flow into the second information flow site;
wherein, displaying the detailed information of the required information element in the first information flow site according to the reading request of the user in the any information flow site, and loading the first information flow into the second information flow site comprise:
determining the information flow site configured to display the detailed information according to a reading habit of the user;
when loading the first information flow into the second information flow, still displaying the second information flow that is in the second information flow site previously in the second information flow site;
restoring the two information flow sites to concurrently display a display status of the information flow when a closing request in allusion to the information element displayed in the first information flow site is detected; and
restoring the two information flow sites to concurrently display the display status of the information flow comprises:
reloading the first information flow into the first information flow site, and deleting the first information flow from the second information flow site; or
reallocating the information flow to be displayed after being preprocessed into the first information flow site and the second information flow site respectively for concurrent display.

2. The asymmetric information flow reading method according to claim 1, wherein, after displaying the detailed information of the required information element in the first information flow site according to the reading request of the user in the any information flow site, and loading the first information flow into the second information flow site, the asymmetric information flow reading method further comprises:
substituting the detailed information of the information element that is being displayed in the first information flow site with detailed information of a newly required information element when a new reading request input into the second information flow site is detected.

3. The asymmetric information flow reading method according to claim 1, wherein, when displaying the detailed information of the required information element in the first information flow site, the asymmetric information flow reading method further comprises:
refreshing the first information flow and the second information flow that are being displayed in the second information flow site according to an input information flow refreshing request.

4. An asymmetric information flow reading apparatus, comprising:
an information preprocessing module, configured to preprocess a width and a height of an original information flow, and stacking the preprocessed information flow in a highly adaptive equal-width manner;
an in-site display module, configured to allocate the information flow to be displayed after being preprocessed into a first information flow site and a second information flow site that are configured in advance respectively for concurrent display, wherein the information flow displayed in the first information flow site is a first information flow, and the information flow displayed in the second information flow site is a second information flow;
a reading response module, configured to display detailed information of a required information element in the first information flow site according to a reading request of a user in any information flow site, and load the first information flow into the second information flow site;
the reading response module, configured to display the detailed information of the required information element in the first information flow site according to the reading request of the user in the any information flow site and load the first information flow into the second information flow site, comprising:
determining the information flow site configured to display the detailed information according to a reading habit of the user;
when loading the first information flow into the second information flow, still displaying the second information flow that is in the second information flow site previously in the second information flow site;
the asymmetric information flow reading apparatus further comprises:
a display restoring module, configured to restore the two information flow sites to concurrently display a display status of the information flow when a closing request in allusion to the information element displayed in the first information flow site is detected; wherein
the display restoring module further comprises:
a first restoring unit, configured to reload the first information flow into the first information flow site, and delete the first information flow from the second information flow site; or
a second restoring unit, configured to reallocate the information flow to be displayed after being preprocessed into the first information flow site and the second information flow site respectively for concurrent display.

5. The asymmetric information flow reading apparatus according to claim 4, further comprising:
a display transformation module, configured to substitute the detailed information of the information element that is being displayed in the first information flow site with detailed information of a newly required information element when a new reading request input into the second information flow site is detected.

6. The asymmetric information flow reading apparatus according to claim 5, further comprising:
an information refreshing module, configured to refresh the first information flow and the second information flow that are being displayed in the second information flow site according to an input information flow refreshing request.
